(19) United States
(12) Patent Application Publication
(10) Pub. No.: US 2024/0174485 A1
(43) Pub. Date: May 30, 2024

(54) MOBILE DEVICE AND METHOD FOR MONITORING A SAFETY CHAIN OF AN ELEVATOR

(71) Applicant: Inventio AG, Hergiswil (CH)

(72) Inventors: Bruno Castro Silva, Sao Paulo (BR); Pietro Panegassi Picchiotti, Sao Paulo (BR); Eduardo Vittorini, Sao Bernardo do Campo (BR); Eduardo De Castro Batista, Londrina, Paranà (BR)

(21) Appl. No.: 18/551,892

(22) PCT Filed: Feb. 23, 2022
(86) PCT No.: PCT/EP2022/054517

§ 371 Date: Sep. 22, 2023

(30) Foreign Application Priority Data
Mar. 30, 2021 (EP) 21166000.6

(51) Int. Cl. B66B 5/00

(52) U.S. Cl. CPC B66B 5/0031; B66B 5/0025

(57) ABSTRACT

A mobile device and a method are used for monitoring a safety chain of an elevator, wherein the safety chain consists of more than one member that are connected electrically in series. The mobile device includes a signal sender, a signal receiver, a timer and a processor and is adapted to connect to an end of the safety chain. The signal sender generates and feeds a first pulse signal into the safety chain, the signal receiver detects a second pulse signal coming out of the safety chain when the safety chain is electrically interrupted, the timer measures the time period between the feeding the first pulse signal and the detecting the second pulse signal, and the processor identifies a member with regard to the time period that has electrically interrupted the safety chain.

### FIELD

The present invention relates particularly to a mobile device and a method for monitoring a safety chain of an elevator. Furthermore, this invention relates to an elevator system that can be monitored by such a mobile device or through such a method.

### BACKGROUND

An elevator may comprise an elevator car that is movable vertically in an elevator shaft (hoistway) and may stop at different floors of a building. Furthermore, the elevator may comprise automatically actuatable shaft doors (also called as landing doors) at the floors that may be opened and closed, when the elevator car stops at the floors. As elevators are applied for transporting passengers along vertical distances, strict safety requirements have to be fulfilled. For instance, if a sensor of an elevator detects that a door lock has not engaged, a controller prevents the movement of the elevator until the issue is resolved.

An elevator system includes a plurality of safety components or parts with a discrete number of switches and contacts etc., which are designed to monitor or indicate the status of the safety components or parts, respectively. Such safety-related switches and contacts are wired electrically together in a series circuit. Such a safety-related circuit is well known as a so-called “safety chain.” A safety chain includes typically a plurality of members like the car door, the landing doors, and some terminal switches in the hoistway of an elevator. The safety chain is normally connected directly to the main control of an elevator via wires. If the safety chain of an elevator is electrically broken or “open” that means at least one of the switches (e.g. a door contact) in this safety chain is not closed, the elevator is deemed “unsafe” and the operation of the elevator will be shut down immediately, e.g. less than 100 ms (microsecond), by the main controller of the elevator, in order to ensure that the elevator will not be operated in an unsafe manner. After this switch has closed, the safety chain is also closed again as a whole, and thereby the operation of the elevator is restored.

An elevator system is an extremely complex system that must be maintained to keep the elevator safe running. Maintenance is a systematic process of inspection which includes finding, diagnosing, and fixing problems before they cause machine breakdown, malfunction, or shutdown. Most maintenance of sensors, switches, and components of an elevator must be performed inside of the shaft and outside of the elevator car. Concerning this, service technicians must often go up on the roof of the elevator car or down to the pit in the shaft during maintenance, accessing to the shaft via shaft doors. Due to the design of the safety chain with series-connected shaft door contacts, if one of the shaft doors is not closed correctly, the whole safety chain keeps as broken or interrupted and the elevator may not be operated. The technician does not know exactly which door is open or whether any other member of this safety chain fails or has a fault. Hence, the technician must go upstairs and downstairs through all the floors of the whole building and has to check every shaft door of the elevator. Even if he has found the open door and closed it, the safety chain could be still broken, in case there is another fault that has been not found. At this time, the technician has already wasted a lot of time and expended a lot of body strength.

### SUMMARY

Accordingly, there may exist a need for improving work efficiency and enhancing personal safety for installing or maintaining an elevator. Such a need may be met with the subject-matter of the advantageous embodiments that are defined in the following specification.

According to the first aspect of the invention, a mobile device is provided for monitoring a safety chain of an elevator system, wherein the safety chain consists of more than one member which are connected with each other electrically in serial. The mobile device comprises a signal sender, a signal receiver, a timer, and a processor that can be activated e.g. either by activating a switch of the mobile device or by starting a specific App installed on this mobile device. The mobile device can be connected to an end of the safety chain so that the signal sender may generate and feed a first pulse signal into the safety chain. This pulse signal may consist of a single pulse or a set of pulses. The first pulse signal then will be transmitted along the safety chain, wherein this signal must have sufficient energy to travel through the whole wire which is used for connecting all members of the safety chain in series. The signal receiver later may detect a second pulse signal coming out of the safety chain if the safety chain is electrically broken or interrupted, as the first pulse signal is reflected in a place where the safety chain is broken or interrupted. This means that in fact the detected second pulse signal is the first pulse signal reflected in the wire of the safety chain. The timer can measure the time period Δt between feeding the first pulse signal into the safety chain and detecting the second pulse signal from the safety chain, and the processor may identify a member of the safety chain concerning the time period Δt, wherein the safety chain has been electrically broken by this identified member. The process here is performed e.g. with a TDR (time-domain reflectometer) that identifies the characteristics of electrical wires or cables by observing reflected waveforms. If the safety chain is not broken or interrupted, the signal receiver should not detect any pulse signal like the previously sent signal. In case that the measured time period Δt has exceeded a pre-set maximal time limit which a signal needs to be transmitted twice through the whole safety chain, the processor may ignore the detected signal, since such a signal should be an interference signal.

According to an embodiment, different reference values of time period Δt′ are assigned respectively to the members of the safety chain so that every member is identifiable by its own unique reference value. The processor may evaluate the measured time period Δt by comparing with these reference values of time period Δt′. If a reference value of time period Δt′ assigned to a member is matched with the measured time period Δt, the processor identifies that this member is not connected to the safety chain. Hereby, matching of a measured value with a reference value means that the difference between these two values is within an acceptable tolerance.

According to an embodiment, the reference values of time period Δt′ can be predefined according to the safety chain and/or the elevator system and saved in an internal memory unit of the mobile device or in an external memory with which the mobile device is capable of communicating. The predefinition can be performed at any time or by anybody before using the mobile device to detect the elevator. The memory unit is e.g. an integrated unit of the mobile device or the elevator. The memory unit can be also a separate device like a USB (Universal Serial Bus) or SD (Secure Digital) card, alternatively, the reference values can be saved in a remote server. The mobile device may communicate with a database or networks, e.g. the Internet.

According to a further embodiment, the processor can identify whether the detected second pulse signal is the first pulse signal generated by the signal sender, wherein the processor may compare the amplitude, the pulse width, and/or the frequency of the detected pulse signal and the generated pulse signal. If the first pulse signal consists of a set of same or different pulses, the processor may check the sequence of these pulses too, wherein the effects of signal loss and attenuation certainly are to be considered.

According to a further embodiment, the mobile device may comprise a user interface (UI) or a Human-machine interface (HMI) for submitting information about the identified member and/or submitting an error message in the case of no reference value of time period Δt′ is matched with the measured time period Δt, namely no member can be identified or found out. The HMI prefers a graphical user interface (GUI). Alternatively or additionally, the mobile device may also comprise a speaker for providing an acoustic message.

According to the second aspect of the invention, a method is proposed to monitor a safety chain of an elevator system, wherein the safety chain consists of more than one member which are connected electrically in series. The method comprises the following steps:
generating a first pulse signal and feeding this pulse signal at an end of the safety chain into the safety chain, wherein the first pulse signal may consist of a single pulse or a set of pulses,
detecting a second pulse signal coming out of the safety chain at this end of the safety chain when the safety chain is electrically broken,
measuring the time period Δt between the feeding the first pulse signal and the detecting the second pulse signal, and
identifying a member concerning the time period Δt, wherein the safety chain has been electrically broken by this identified member. Advantageously, the identification of the member requires identifying whether the detected second pulse signal is the first pulse signal generated by the signal sender.

According to an embodiment, the method further comprises steps:
assigning a different reference value of time period Δt′ to every member of the safety chain,
comparing the measured time period Δt with the reference values of time period Δt′, and
identifying the member of the safety chain when the reference value of time period Δt′ assigned to this member is matched with the measured time period Δt.

According to an embodiment, the reference values of time period Δt′ are predefined according to the safety chain and/or the elevator system and saved in an internal memory of an elevator system or in an external memory.

According to an embodiment, the method further comprises steps:
submitting information about the identified member and/or submitting an error message in the case of no reference value of time period Δt′ is matched the measured time period Δt.

According to another embodiment, the method is executable by a mobile device, wherein the mobile device is capable of connecting to the safety chain. The mobile device could be a smartphone, a portable computer (laptop, tablet, PDA), or another kind of mobile terminal, etc. that can be modified as needed. For example, an App (Application software) installed on the smartphone can be activated by a technician to execute the method, when he has noticed that the safety chain is broken or interrupted.

According to the third aspect of the invention, an elevator system is proposed that can be monitored by an aforementioned mobile device or through an aforementioned method.

It shall be noted that the possible features and advantages of embodiments of the invention are described herein concerning a mobile device, a method, and an elevator system mentioned above. One skilled in the art will recognize that the features may be suitably transferred from one embodiment to another and features may be modified, adapted, combined, and/or replaced, etc., in order to come to further embodiments of the invention. Ideas underlying embodiments of the present invention may be interpreted as being based, inter alia, and without restricting the scope of the invention, on the following observations and recognitions.

In the following, advantageous embodiments of the invention will be described regarding the enclosed drawings. However, neither the drawings nor the description shall be interpreted as limiting the invention.

### DESCRIPTION OF THE DRAWINGS

FIG. 1 shows an elevator with a safety chain connected with a mobile device according to the present invention;

FIG. 2 shows a mobile device according to the present invention;

FIG. 3 shows an exemplary embodiment for identifying a member which breaks the safety chain.

### DETAILED DESCRIPTION

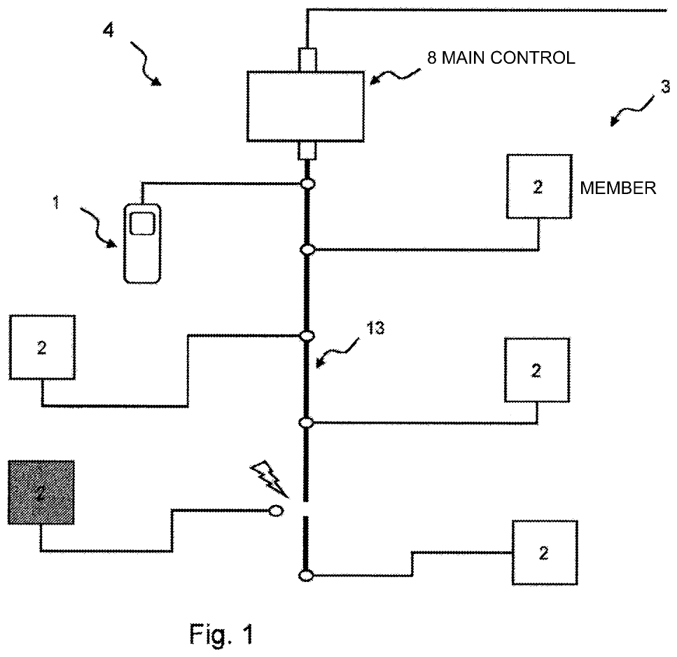

FIG. 1 shows an elevator system 4 with a safety chain 3 which comprises a plurality of members 2. For simplicity purposes, the members 2 in this embodiment are only the shaft doors 2 of the elevator 4 that are connected electrically together in series by a cable 13. An end of the cable 13 is connected to an elevator main control 8,

[symbol]

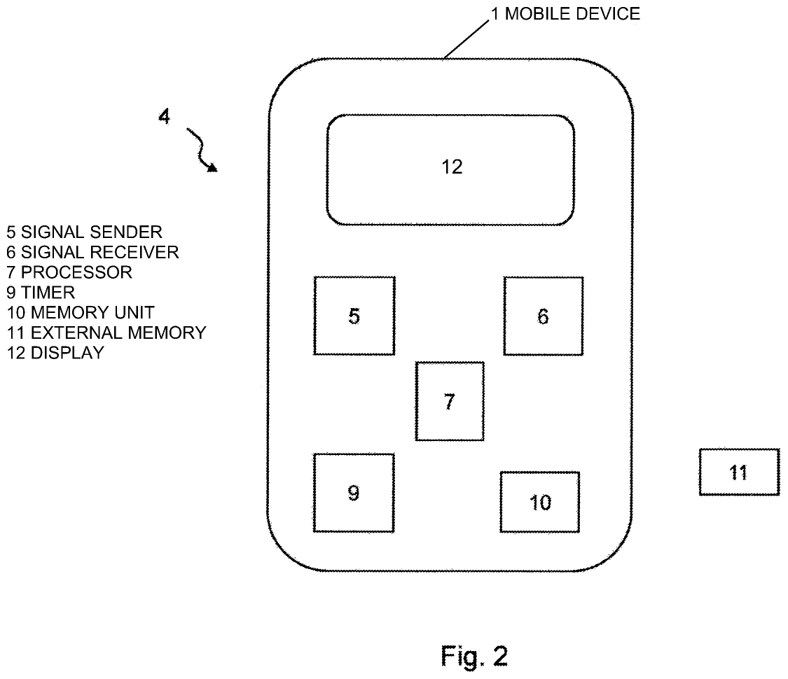

A mobile device 1, e.g. a smartphone is assigned to a technician who will perform an inspection or a maintenance work for the elevator 4. As shown in FIG. 2, the mobile device 1 comprises a signal sender 5, a signal receiver 6, a timer 9, a processor 7, and a display or a touchscreen 12 that functions as a user interface. For instance, the safety chain 3 is broken or interrupted e.g. at a member 2 which is shown in gray (shaded) in FIG. 1. However, the technician realizes only that the safety chain 3 is broken, but he does not know where exactly it is. The technician does not need to go through every floor of the building in which the elevator 4 is located to find out where the safety chain 3 is broken or which shaft door 2 is not closed, instead of this, he may connect the mobile device 1 to an end of the cable 13 of the safety chain 3. Then, the technician may e.g. use an App that is installed on the mobile device 1 to activate the signal sender 5 to generate a first pulse signal and feed this signal into the cable 13. This first pulse signal may consist of a single pulse or a set of pulses. The signal receiver 6 is able to detect a second pulse signal. The timer 9 can measure the time period Δt between feeding the first pulse signal and detecting the second pulse signal. To avoid possible signal interference or other errors, the processor 7 will check at first whether the detected second pulse signal is the previously generated first pulse signal fed into the cable 13. For this purpose, the processor 7 may compare the amplitude, the pulse width and/or the frequency of the received pulse signal and the generated pulse signal. If the received second pulse signal is not the same as the first signal generated before, the processor 7 will ignore this received pulse signal.

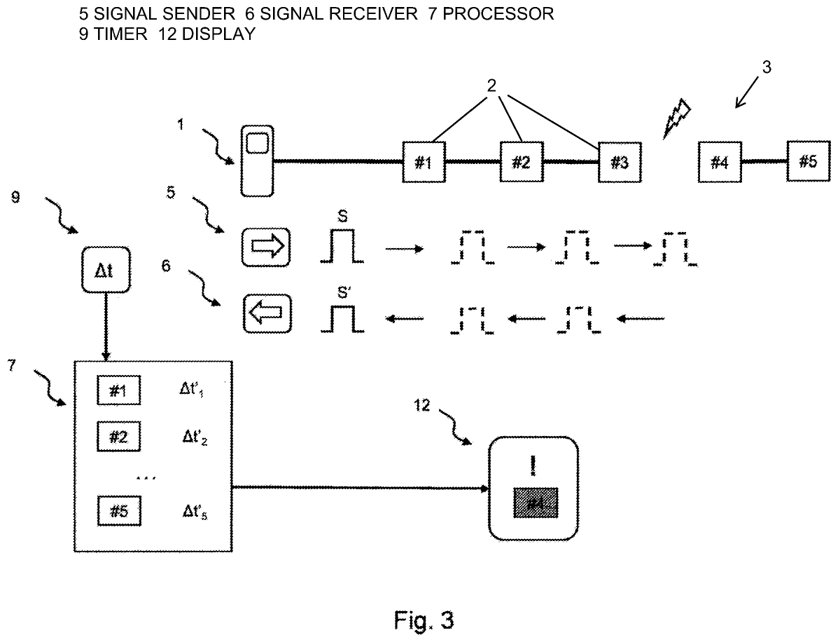

If the detected pulse signal has been verified as the first pulse signal, this means that the first pulse signal is reflected at the interrupted point of the safety chain 3 and transmitted back to the end of the safety chain 3. On the display 12 of the mobile device 1 the whole safety chain 3 with all shaft doors 2 is displayed (see FIG. 3). Optionally, the generated and the detected pulse signal may also be displayed.

To every member 2, namely every shaft door, of the safety chain 3, a reference value of time period Δt′ is assigned and saved as a value table in a memory unit 10 of the mobile device 1 or in an external memory 11, e.g. a USB (Universal Serial Bus) or SD (Secure Digital) card, which can be read by the mobile device 1. Alternatively, these reference value of time period Δt′ can be also saved in a data server which is accessible to the mobile device 1 for calling, unloading, or uploading data.

Particularly, for instance, these reference values are specified according to the length of the cable 13, a distance between two members 2, and the frequency of the pulse signal. If the pulse width of a pulse signal is 50 ns (nanosecond), then the maximum sampling frequency of the pulse generator/sender 5 and the detector 6 is 40 KHz. Hence, the propagation speed v of the pulse signal in the cable 13 can be calculated e.g. in the high-frequency range by a simplified mathematical formula:

$$v = \frac{c}{\sqrt{{ε}_{r}}}$$

The εᵣ is the dielectric constant of the cable 13, for metal normally 1<εᵣ<10, and c for the speed of light is 30 cm/ns. If the dielectric constant εᵣ=4, the propagation speed v of the pulse signal in this cable is 15 cm/ns.

After the received pulse signal has been identified, the processor 7 will compare the measured time period Δt with the value table saved in the memory unit 10 or 11. If a reference value of time period Δt′ assigned to a member 2 has been found that this reference value Δt′ is matched with the measured time period Δt, the processor 7 identifies that this member 2 is not closed and thus breaks the safety chain 3. And the member 2 broken from safety chain 3 is shown on the display 12. Otherwise, an error message can be submitted to the technician and displayed on the display 12 or sent from a speaker of the mobile device 1 if none of the reference values of time period Δt′ has been found which can match the measured time period Δt. For instance, the error message may refer to such as a failure of estimating or measuring the time period Δt. Alternatively, the error message may also instruct the user of the mobile device (e.g. technician) that the reason for the interruption that the cable of the safety chain could be defective. Based on the measured time period Δt, the technician may still at least specify approximately where in the safety chain a problem could exist. Moreover, if the measured time period Δt exceeds a maximal time limit which a signal needs to be transmitted twice (in the and out) through the whole safety chain. In this case, the processor may ignore this received second pulse signal, since this second pulse signal is considered as an interference signal.

FIG. 3 shows the following steps of the method according to the present invention. For instance, the member 2 numbered #4 of the safety chain 3 is left open or interrupted so that the reflection factor r is 1 (r=1). A pulse signal or a series of pulses S sent by the signal sender 5 then theoretically will be reflected completely in this place and transmitted back to the end of the cable 13. At first, the processor 7 (see FIG. 2) will check whether the pulse signal S′ detected by the signal receiver 6 is the reflected signal S sent before. If this case is met, then based on this signal S′ the processor 7 compares the measured time period Δt with the reference values Δt′ₙ (n representing the member number) saved in the memory unit 10 in their order, until one of these reference values Δt′ₙ which is assigned to the shaft door #4 is found. Consequently, it may conclude that the reason for the interruption of the safety chain 3 is that the shaft door #4 as a member 2 of the safety chain 3 stays open. On the display 12 a symbol of this shaft door #4 is displayed to notify the technician of where the safety chain 3 is broken.

Finally, it should be noted that the term “comprising” does not exclude other elements or steps, and the “a” or “an” does not exclude a plurality. Also, elements described in association with different embodiments may be combined.

In accordance with the provisions of the patent statutes, the present invention has been described in what is considered to represent its preferred embodiment. However, it should be noted that the invention can be practiced otherwise than as specifically illustrated and described without departing from its spirit or scope.

1-15. (canceled)

16. A mobile device for monitoring a safety chain of an elevator system, the safety chain including at least two members connected electrically in series, the mobile device comprising:
a signal sender, a signal receiver, a timer and a processor;
wherein when the mobile device is connected to an end of the safety chain, the signal sender selectively generates and feeds a first pulse signal into the safety chain;
wherein the signal receiver is adapted to detect a second pulse signal coming out of the safety chain in response to the first pulse signal when the safety chain is electrically interrupted;
wherein the timer is adapted to measure a time period between the feeding of the first pulse signal by the signal sender and the detecting of the second pulse signal by the signal receiver; and
wherein the processor identifies one of the members associated with the measured time period as causing the electrical interruption of the safety chain.

17. The mobile device according to claim 16 wherein each of the members in the safety chain is assigned a different time period reference value and the processor compares the measured time period with the time period reference values, and wherein the processor identifies the one member of the safety chain causing the safety chain to be electrically interrupted when the time period reference value assigned to the one member matches the measured time period.

18. The mobile device according to claim 16 wherein the time period reference values are predefined based upon the safety chain and/or the elevator system and are saved in an internal memory unit of the mobile device and/or in an external memory unit with which the mobile device is adapted to communicate.

19. The mobile device according to claim 16 wherein the signal sender generates the first pulse signal as a single pulse or a set of pulses.

20. The mobile device according to claim 16 wherein the processor identifies whether the detected second pulse signal is the first pulse signal generated by the signal sender.

21. The mobile device according to claim 20 wherein the processor compares at least one of an amplitude, a pulse width and a frequency of the detected second pulse signal and the generated first pulse signal to identify the one member.

22. The mobile device according to claim 16 wherein each of the members of the safety chain is assigned a different time period reference value and the processor compares the measured time period with the time period reference values, the mobile device including a user interface submitting to a user of the mobile device information about the identified one member and/or an error message when none of the time period reference values matches the measured time period.

23. An elevator system comprising:
a safety chain including at least two members connected electrically in series; and
a mobile device according to claim 16 connected to and monitoring the safety chain.

24. A method for monitoring a safety chain of an elevator system, the safety chain including at least two members connected electrically in series, the method comprising the steps of:
generating a first pulse signal and feeding the first pulse signal into the safety chain at an end of the safety chain;
detecting a second pulse signal coming out of the safety chain at the end of the safety chain in response to the first pulse signal when the safety chain is electrically interrupted;
measuring a time period between the feeding of the first pulse signal and the detecting of the second pulse signal; and
identifying one of the members of the safety chain associated with the time period as causing the electrical interruption of the safety chain.

25. The method according to claim 24 including:
assigning a different time period reference value to each of the members in the safety chain;
comparing the measured time period with the time period reference values; and
identifying the one member when the time period reference value assigned to the one member matches the measured time period.

26. The method according to claim 25 including predefining the time period reference values based upon the safety chain and/or the elevator system and saving the predefined time period reference values in an internal memory unit of the elevator system and/or in a memory unit external to the elevator system.

27. The method according to claims 24 including generating the first pulse signal as a single pulse or a set of pulses.

28. The method according to claim 24 including identifying whether the detected second pulse signal is the first pulse signal generated by the signal sender.

29. The method according to claim 24 including displaying information about the identified one member and/or an error message when the measured time period is not associated with any of the members.

30. The method according to claim 24 including performing the method steps using a mobile device adapted to connect to the safety chain.

31. An elevator system comprising a safety chain the safety chain including at least two members connected electrically in series and being monitored by the method according to claim 24.
